(19) United States
(12) Patent Application Publication
(10) Pub. No.: US 2026/0091805 A1
(43) Pub. Date: Apr. 2, 2026

(54) CRASH REPORT ADJUDICATION FOR AUTONOMOUS VEHICLES

(71) Applicant: NVIDIA Corporation, Santa Clara, CA (US)

(72) Inventors: Jay Patrikar, Pittsburgh, PA (US); Apoorva Sharma, Oakland, CA (US); Sushant Veer, Sunnyvale, CA (US); Yulong Cao, Watchung, NJ (US); Wenhao Ding, San Jose, CA (US); Karen Leung, Seattle, WA (US); Rachel Luo, Mountain View, CA (US); Boyi Li, Berkeley, CA (US); Marco Pavone, Stanford, CA (US)

(21) Appl. No.: 19/092,815

(22) Filed: Mar. 27, 2025

Related U.S. Application Data
(60) Provisional application No. 63/701,981, filed on Oct. 1, 2024.

(51) Int. Cl. B60W 60/00; B60W 50/00; G05B 13/02

(52) U.S. Cl. CPC B60W 60/001; B60W 50/00; G05B 13/0265; B60W 2050/0022

(57) ABSTRACT

An autonomous vehicle (AV) can utilize quantitative data, such as data received from sensors with known intrinsic parameters (e.g., positive data) to determine a second subsequent action from a set of possible actions, using inputs such as an original subsequent action. To improve the decision-making process of the second subsequent action, the AV can utilize qualitative data, such as data received from a data storage system (e.g., negative data). Qualitative data can be text or image based, such as from a crash report or sensor data missing sufficient intrinsic parameters to make a quantitative evaluation. By weighting the quantitative data against the qualitative data, the decision-making process of the AV towards its high-level goal (such as moving toward a parking lot) can be more efficient, such as ensuring lower levels goals are met. The decision process can utilize multi-modal large language models and latent space models to weight data appropriately.

### CROSS-REFERENCE

This application claims the benefit of U.S. Provisional Application Ser. No. 63/701,981, filed by Jay Patrikar, et al., on Oct. 1, 2024, entitled “CRASH REPORT ADJUDICATION FOR AUTONOMOUS VEHICLES,” commonly assigned with this application and incorporated herein by reference in its entirety.

### TECHNICAL FIELD

This application is directed, in general, to using driving data to improve autonomous vehicle (AV) learning and, more specifically, to using quantitative and qualitative data for the AV learning.

### BACKGROUND

Recent advances in AV navigation stacks rely increasingly on black-box machine-learning methods to provide real-time nuanced decision-making. While these methods have improved the general driving performance of AVs, this progress has been achieved at the cost of reduced transparency in how these driving decisions are made. As AVs increasingly encounter complex real-world scenarios, they need to make decisions that lead to safe and legal outcomes. Within jurisprudence, a precedent refers to a principle or rule established in a legal case that becomes authoritative to a court when deciding subsequent cases with similar facts. With growing calls for accountability in autonomous decision-making, the ability to use verifiable precedents to adjudicate critical driving decisions on the fly is crucial in improving trust and explainability of learning-based systems.

### SUMMARY

In one aspect a method is disclosed. In one embodiment, the method includes (1) receiving sensor data collected from one or more sensors located with an ego autonomous vehicle (AV), wherein the sensors have known intrinsics, (2) receiving qualitative decision data involving the ego AV, wherein the qualitative decision data lacks known intrinsics, (3) determining an AV decision for the ego AV using the sensor data and the qualitative decision data, wherein a set of possible actions towards a high-level goal is evaluated for an original subsequent action of the ego AV, and, for each possible action in the set of possible actions, a weighting of the qualitative decision data relative to the sensor data is adjusted according to an amount of support the qualitative decision data has for the each possible action, and (4) directing the ego AV to a second subsequent action using the AV decision.

In a second aspect, a system is disclosed. In one embodiment, the system includes (1) a data storage system capable of storing qualitative decision data from a scene involving an ego autonomous vehicle (AV), (2) a sensor system capable of collecting sensor data from one or more sensors, and (3) an AV decision processor capable of using the sensor data and the qualitative decision data, wherein a set of possible actions is evaluated for an original subsequent action of the ego AV towards a high-level goal, and, for each possible action in the set of possible actions, a weighting of the qualitative decision data relative to the sensor data is adjusted according to an amount of support the qualitative decision data provides for respective of the each possible action, and recommending a second subsequent action to the ego AV.

In a third aspect, a non-transitory computer program product having a series of operating instructions stored on a non-transitory computer-readable medium that directs an ego autonomous vehicle (AV) process when executed thereby to perform operations. In one embodiment, the operations include (1) receiving sensor data collected from one or more sensors located with an ego autonomous vehicle (AV), wherein the sensors have known intrinsics, (2) receiving qualitative decision data involving the ego AV, wherein the qualitative decision data lacks known intrinsics, (3) determining an AV decision for the ego AV using the sensor data and the qualitative decision data, wherein a set of possible actions towards a high-level goal is evaluated for an original subsequent action of the ego AV, and, for each possible action in the set of possible actions, a weighting of the qualitative decision data relative to the sensor data is adjusted according to an amount of support the qualitative decision data has for each possible action, and (4) directing the ego AV to a second subsequent action using the AV decision.

### BRIEF DESCRIPTION

Reference is now made to the following descriptions taken in conjunction with the accompanying drawings, in which:

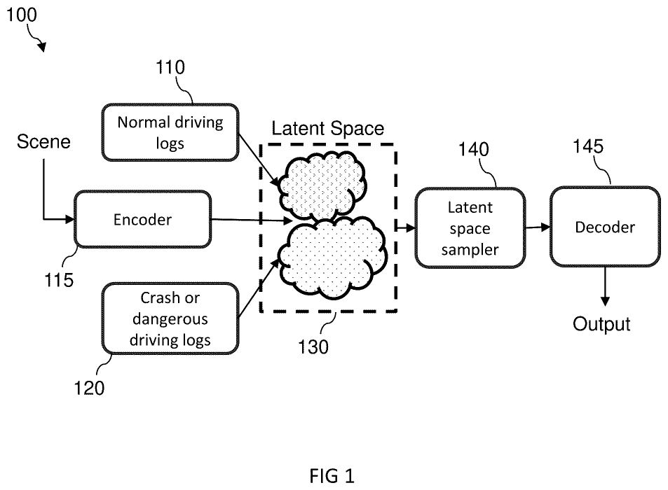

FIG. 1 is an illustration of a diagram of an example flow demonstrating the use of quantitative and qualitative decision data;

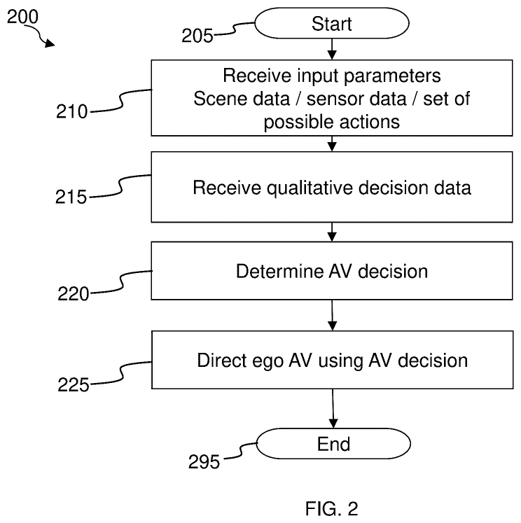

FIG. 2 is an illustration of a flow diagram of an example method of making an AV decision carried out according to the principles of the disclosure;

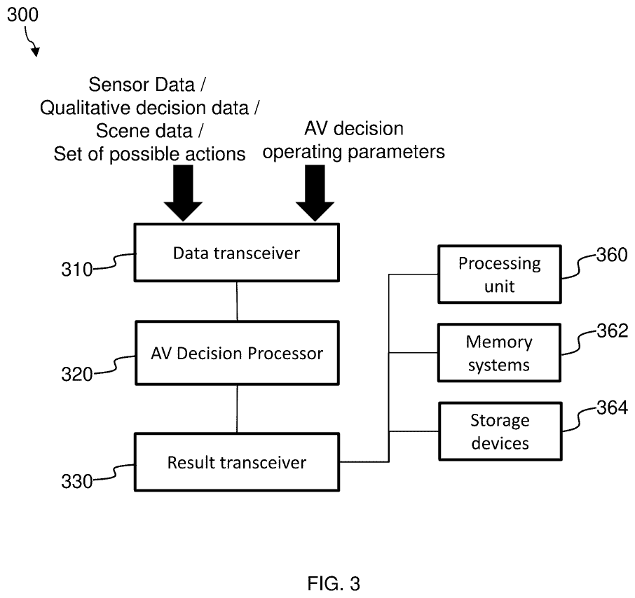

FIG. 3 is an illustration of a block diagram of an example AV decision system; and

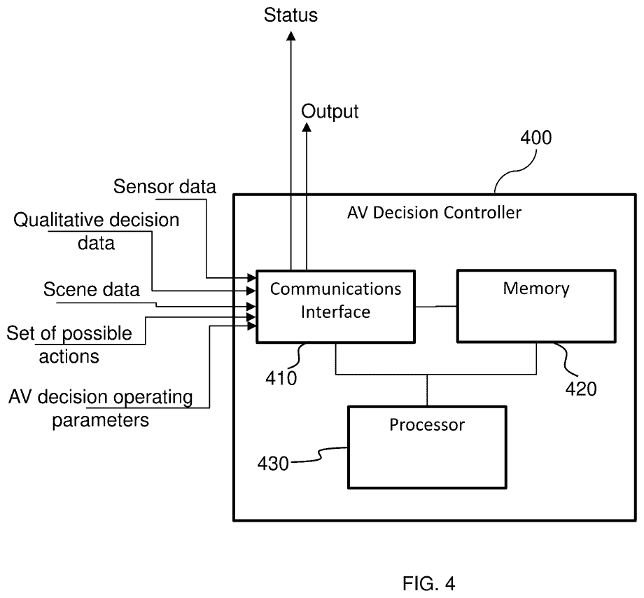

FIG. 4 is an illustration of a block diagram of an example of an AV decision controller according to the principles of the disclosure.

### DETAILED DESCRIPTION

This disclosure aims to improve the safety, legality, and interpretability of black-box learning-based end-to-end decision-making of autonomous vehicles (AVs) by grounding decisions in real-world historical precedents. AVs can be various types of automated vehicles, such as cars, trucks, robots, spacecraft, rockets, or other vehicles that can move without a human operator actively controlling the vehicle. Human drivers rely on their understanding of laws, reasonable behaviors on the road, and historical knowledge of a scenario to inform their driving decisions. This disclosure aims to use explicit qualitative (e.g., negative data, such as crash reports) and quantitative (e.g., positive data, such as intrinsic sensor data) examples of driving behavior to provide decision support and justifications by counterfactually reasoning about various decisions available to the AV during deployment. By projecting the examples in a shared informed representation space, given a novel scene, the method uses a guided retrieval process to extract semantically relevant scenarios. These retrievals can then be used to generate the final action and provide justifications for every possible action of the AV. Real-world multi-modal crash data reports as well as safe data collected by human drivers can be utilized to generate the results.

State-of-the-art AV navigation stacks can rely on large-scale human driving datasets to train behaviors with the aim of aligning the AV's decisions with human-like decision-making. While these datasets cover a wide range of scenarios, they mostly contain quantitative incident-free interactions. The access to quantitative driving data confines the AVs to reason about scenarios that fall within the quantitative spectrum of the driving experience, hampering the ability to effectively reason about qualitative outcomes. Humans can use quantitative and qualitative experiences to inform their decisions while driving in complex scenarios.

Automobile crash reports can be a rich source of qualitative interactions. The National Highway Traffic Safety Administration (NHTSA) is an agency of the U.S. federal government that collects and publishes detailed crash data to help scientists and engineers analyze motor vehicle crashes and injuries. The crash reports, collected since the early 1970s, can be used to provide AVs with an understanding of qualitative outcomes for certain actions, providing the necessary grounding for counterfactually evaluating various driving decisions. Unlike the quantitative data which is collected on vehicles instrumented with many sensors (e.g., multiple cameras with known intrinsics, inertial measurement units (IMU), GPS, and other sensors), qualitative data can be less precise, e.g., taking the form of a text description or dashcam video footage.

This disclosure provides a framework that enables the use of quantitative and qualitative examples of driving behavior (e.g., ego AV behavior) to provide a more holistic and transparent understanding of autonomous decisions. Given a particular scenario, an AV needs to reason about possible feasible actions and the impact of these actions on the other agents. Historical data can be used to provide corroborating evidence for each of the possible actions. The strength and direction of this support informs the action choice for the AV. The AV that is deciding is called the ego vehicle. Other AVs and other objects (e.g., agents) can be present in the collected sensor data that is used in the decision-making process. Each AV can be considered an ego vehicle when looking at its respective decision-making process. An ego vehicle is the AV that is focused on for the decision-making process.

Autonomous agents that rely on learning-based end-to-end decision-making are being increasingly deployed in safety critical scenarios. The black-box nature of these methods has prompted research in providing justifications and reasoning to ensure safer and more trustworthy decision-making. Explainable artificial intelligence (AI) (X-AI) is a sub-branch of AI research that focuses on the capability of AI systems to explain their behavior in human-understandable ways. Within self-driving, a few X-AI approaches have gained more prominence. Visual saliency maps are a natural way to represent the attention of the model around the ego vehicle while their effectiveness in downstream decision-making can be challenging. In addition to saliency maps, recent end-to-end models provide access to intermediate latent representations for other tasks like image segmentation, depth estimation, and trajectory prediction. The outputs of these tasks can be used to arbitrate between desirable and undesirable behaviors while the downstream impact of these intermediate representations in the final output can be unclear.

Language provides another modality for conveying driving decisions. Several methods that use vision and language captions for providing decision explanations exist and focus on quantitative scenarios. Critical scenario identification (CSI), especially as it pertains to autonomous driving behavior, can be a key component in the larger verification and validation pipeline. Classically, methods drawn from reachability theory have been used to provide an understanding of a “criticality” of a particular interaction. Vanilla reachability uses the worst-case assumption on the behavior of other agents which makes it overly conservative, limiting its use in real-world situations.

While methods that assume a more reasonable behavior from other agents have been proposed, the effectiveness of these methods in distribution shifts and high-dimensional data are not well known. Uncertainty quantification (UQ) is another paradigm that can be used to identify unsafe scenarios given a dataset of safe scenarios. While UQ methods can be effective in identifying scenarios that are far from the safe distribution, these methods tend to be more conservative as out-of-distribution scenarios can be classified as unsafe and the methods tend to not offer counterfactuals. Rules and catalog-based methods that rely on humans to craft hand engineered rules have also been proposed. These methods can be painstaking to develop and can struggle with far edge case scenarios that were overlooked during development.

The disclosed processes use quantitative and qualitative examples of driving behavior. In some aspects, multi-modal data can be used, such as with multiple cameras, lidar, or aligned text descriptions of the scenarios. The text descriptions can be human annotated or auto generated by an auto labeling technique. An example of a qualitative scenario text description is shown in Table 1.

TABLE 1
Example Text Description of a Crash Report

Ego vehicle was travelling on a two-lane road with opposing traffic. Ego
vehicle crossed the solid yellow lines with another vehicle on the opposite
lane. Ego vehicle collided with the other vehicle.

Given a particular scene, the ego vehicle can be tasked with choosing an action towards achieving a pre-specified high-level goal. The high-level goal can be, for example, a route plan, a movement, an action, a language instruction, or other types of goals. Given the position of the ego vehicle within a map as well as position and possible intents of other agents, the ego vehicle can generate one or more possible actions (e.g., a set of possible actions to be evaluated) which can be feasibly executed. The goal of an AV decision making process can be to reason among the possible actions in the set of possible actions ensuring the safety and progress towards that goal.

This work aims to find evidence from non-quantitative decision data that can positively or negatively support each of these possible actions. If a particular decision has more support from the qualitative decision data (as compared to the quantitative sensor data, e.g., having known intrinsic parameters), then the qualitative decision data can provide more weight to that possible action than the quantitative sensor data. The weighting can be in the positive direction or the negative direction depending on what the qualitative decision data states. For example, if the qualitative decision data states that the ego vehicle performed correctly while another agent vehicle was driven by an impaired driver, then the qualitative decision data can be weighted positively toward the action being evaluated (e.g., given a higher weight). If the qualitative decision data states that the ego vehicle crossed the yellow line inappropriately, then the qualitative decision data can be weighted negatively toward the action being evaluated (e.g., given a lower weight).

Given a historical dataset of quantitative and qualitative examples, the proposed work aims to semantically tie each of these decisions to either side of the spectrum by providing concrete examples from the data in support of these different decision modalities. Given the multi-modal nature of the problem, fine-tuning and re-purposing of a multi-modal large language model (MM-LLM) encoder is recommended to align the text and image descriptions of a scene into a shared embedding space. The use of language ensures that the embedding space is capable of semantically aggregating the scenes guarding against spurious correlations. The embedding space is further refined by using contrastive losses to segregate quantitative and qualitative samples. The historical data (e.g., data sourced from a database or data storage system) can be indexed to be later used in a retrieval mechanism to provide evidence to corroborate future actions.

Turning now to the figures, FIG. 1 is an illustration of a diagram of an example flow 100 demonstrating the use of quantitative and qualitative decision data. Flow 100 provides a high-level diagram for the disclosed processes. A multi-modal encoder, a latent-space sampler, and a generator decoder can be used. The quantitative and qualitative decision data examples can be encoded using a multi-modal encoder into a shared latent embedding space. Given a scene for the ego AV, a set of possible actions available to the agent can be generated. For each ego history and action pair, the joint encoder can be used to map the action to this embedding space. In some aspects, the encoder can be fine-tuned with ego vehicle action logs to improve the embedding space. In some aspects, the encoder can be trained using masked inputs to improve robustness to missing or noisy inputs.

Flow 100 includes an input 110 representing the normal driving logs that can be received from a data store, such as a data store on the ego AV or a remote data store. The driving logs can be generated from data collected from sensors on the ego AV or sensors located at the scene. An input 120 can represent crash logs or dangerous driving logs, for example, police reports, data gathered from other sensors, and logs such as logs from other AVs or sensors not related to the ego AV. An encoder 115 can encode multi-modal data, scene data, and other inputs, such as using an LLM or a MM-LLM. Other types of encoders can be used instead of LLM encoder types.

A latent space sampler 140 can use learned similarity functions to retrieve the semantically k-nearest data points to the input and action pairs from a latent space 130. By measuring the degree of closeness as well as the class to which the retrieved examples belong, a measure on the “reasonableness” of each action can be determined. Care should be taken that the sampler does not correlate scenarios based on confounding factors. The sampler should use causal relations to provide faithful retrievals.

A decoder 145 uses the input as well as the retrieved examples to produce outputs, which can be a prediction that would benefit from experience of quantitative and qualitative action experiences relevant to the current scene. For example, the decoder can directly provide a recommended ego plan, a predicted contender AV trajectory, or an evaluation of a candidate ego plan. The structure of the decoder can vary. In the case of estimating a safety score of a candidate plan, a design can be a k-nearest neighbor classifier to estimate whether the scene and plan are closer to more qualitative or quantitative examples.

In some aspects, a higher-capacity decoder can perform complex predictions informed by the retrieved examples. For example, a diffusion trajectory generation model can predict future contender agent behavior conditioned on retrieved quantitative and qualitative examples, ensuring diverse generations which aren't biased towards a particular goal, such as safe driving.

In some aspects, an LLM decoder can use the retrieved examples as context when reasoning about safety or ego planning in the scene. The processes have the potential to improve these downstream tasks by reducing the impact of a particular goal, such as safe-driving bias that some AV datasets have, by bringing in relevant qualitative examples from other data modalities.

FIG. 2 is an illustration of a flow diagram of an example method 200 of making an AV decision carried out according to the principles of the disclosure. Method 200 can be performed on a computing system, for example, AV decision system 300 of FIG. 3 or AV decision controller 400 of FIG. 4. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 200 can be encapsulated in software code or in hardware, for example, an application, code library, code module, dynamic link library, module, function, RAM, ROM module, and other software and hardware implementations. The software can be stored in a file, database, or other computing system storage mechanism. Method 200 can be partially implemented in software and partially in hardware. Method 200 can perform the steps for the described processes, for example, transforming an input into a format suitable for use with a matrix multiplication process and recompose the output to compute a final result.

Method 200 starts at a step 205 and proceeds to a step 210. In step 210, input parameters are received. The input parameters can include scene data. This is information regarding where the AV is located and weather conditions. Scene data can include how many other objects (agents), or AVs are within the scene, where they are located, their respective vectors of movement, or what actions those other objects are taking. The input parameters can include sensor data. The sensor data can be collected from one or more sensors located with the ego AV or from a source within the scene, for example, a traffic or security camera. The sensor data should have sufficient intrinsic parameters to allow the disclosed processes to appropriately tag the sensor data. Sensor data can be collected from cameras, LiDars, Radars, acoustic sensors, thermal sensors, inertial sensors, or other types of sensors. Input parameters can include a set of possible actions that the ego AV can take as an original subsequent action. The set of possible actions can be derived from the high-level goal of the AV. For example, if the ego AV wants to enter a parking lot, then the set of possible actions can include moving forward, waiting for a pedestrian to cross the crosswalk, moving to the side to avoid a car exiting the parking lot, backing up to allow another vehicle to enter first, or other types of possible actions.

In a step 215, qualitative decision data is received. The qualitative decision data does not necessarily have intrinsic parameters available to be tagged. Qualitative decision data can be text, images, other data, or combinations thereof. This data tends to not be available immediately to the ego AV, as this data can come from written accident reports, images taken from a non-intrinsic sensor source, or other sources. Qualitative decision data can be stored in a database or data storage system for retrieval. Qualitative decision data can be processed by an LLM to allow the data to be used by method 200.

In a step 220, an AV decision system can receive the input parameters and the qualitative decision data. The AV decision system can then process the received inputs using various types of encoders, mappings into a latent space, or otherwise mapped to the set of actions to provide a relative weighting of the qualitative decision data can provide to the set of possible actions against the sensor data. In a step 225, the weighted results can be compared to determine a recommended action (e.g., recommended ego AV plan) from the set of possible actions that the ego AV can take. In some aspects, the recommended action, e.g. an AV decision, can be communicated to an ego AV to direct action. In some aspects, the recommended action can be used to train an ego AV decision model, which subsequently can be used to direct action of an ego AV. Method 200 ends at a step 295.

FIG. 3 is an illustration of a block diagram of an example AV decision system 300. AV decision system 300 can be implemented in one or more computing systems or one or more processors. In some aspects, AV decision system 300 can be implemented using an AV decision controller such as AV decision controller 400 of FIG. 4. AV decision system 300 can implement one or more aspects of this disclosure, such as method 200 of FIG. 2.

AV decision system 300, or a portion thereof, can be implemented as an application, a code library, a dynamic link library, a function, a module, a header file, other software implementation, or combinations thereof. In some aspects, AV decision system 300 can be implemented in hardware, such as a ROM, a graphics processing unit, or other hardware implementation. In some aspects, AV decision system 300 can be implemented partially as a software application and partially as a hardware implementation. AV decision system 300 is a functional view of the disclosed processes and an implementation can combine or separate the described functions in one or more software or hardware systems.

AV decision system 300 includes a data transceiver 310, an AV decision processor 320, and a result transceiver 330. The output, e.g., the result, can be communicated to a data receiver, such as one or more of a processing system 360 (one or more combinations of processor units or processing cores), one or more memory systems 362, or one or more storage devices 364.

In some aspects, the results of the AV decision system 300, such as those communicated to the one or more processing systems 360, one or more storage devices 364, or one or more memory systems 362, can be used as an input into another process or system, for example, being used as an input to other AV decision algorithms.

Data transceiver 310 can receive the input parameters, including the sensor data, the qualitative decision data, scene parameters, and ego AV operating parameters. In some aspects, data transceiver 310 can be part of AV decision processor 320.

Result transceiver 330 can communicate one or more outputs, to one or more data receivers, such as processing systems 360, one or more memory systems 362, one or more storage devices 364, or other related systems, whether located proximate result transceiver 330 or distant from result transceiver 330. Data transceiver 310, AV decision processor 320, and result transceiver 330 can be, or can include, conventional interfaces configured for transmitting and receiving data. Data transceiver 310, AV decision processor 320, or result transceiver 330 can be implemented as software components, for example, a virtual processor environment, as hardware, for example, circuits of an integrated circuit, or combinations of software and hardware components and functionality. The functionality described for these components remains intact regardless of how the functionality is implemented.

AV decision processor 320 (e.g., one or more processing units such as processor 430 of FIG. 4) can implement the analysis and algorithms as described herein utilizing the input parameters. AV decision processor 320 can be one or more of a multicore processor, a multiprocessor system, or a streaming multiprocessor. AV decision processor 320 can be implemented by a central processing unit (CPU), a graphics processing unit (GPU), or other types of processors. In some aspects, AV decision processor 320 can receive sensor data as input parameters from one or more sensor systems, such as located with the ego AV, located in another AV, or located at the scene.

A memory or data storage system of AV decision processor 320 can be configured to store the processes and algorithms for directing the operation of AV decision processor 320. AV decision processor 320 can include a processor that is configured to operate according to the analysis operations and algorithms disclosed herein, and an interface to communicate (transmit and receive) data.

FIG. 4 is an illustration of a block diagram of an example of an AV decision controller 400 according to the principles of the disclosure. AV decision controller 400 can be stored on one computer or multiple computers. The various components of AV decision controller 400 can communicate via wireless or wired conventional connections. A portion or a whole of AV decision controller 400 can be located at one or more locations. In some aspects, AV decision controller 400 can be part of another system (e.g., processor, core, server, or other systems), and can be integrated with one device, such as a part of a processing system. AV decision controller 400 represents a demonstration of the functionality employed for the disclosure, and implementations can use a variety of devices, for example, circuits of a processor, dedicated processors, virtual systems, servers, other computing or processing systems, be in software or hardware, or various combinations thereof.

AV decision controller 400 can be configured to perform the various functions disclosed herein including receiving input parameters and generating results from execution of the methods and processes described herein, such generating a final result representing the recommended action for an ego AV. AV decision controller 400 includes a communications interface 410, a memory 420, and a processor 430.

Communications interface 410 is configured to transmit and receive data. For example, communications interface 410 can receive the input parameters. Communications interface 410 can transmit the output or interim outputs. In some aspects, communications interface 410 can transmit a status, such as a success or failure indicator of AV decision controller 400 regarding receiving the various inputs, transmitting the generated outputs, or producing the results.

In some aspects, processor 430 can perform the operations as described by AV decision processor 320. Communications interface 410 can communicate via communication systems used in the industry. For example, wireless or wired protocols can be used. Communication interface 410 can perform the operations as described for data transceiver 310 and result transceiver 330 of FIG. 3.

Memory 420 can be configured to store a series of operating instructions that direct the operation of processor 430 when initiated, including supporting code representing the algorithm for implementing the AV decision processes. Memory 420 is a non-transitory computer-readable medium. Multiple types of memory can be used for the data storage systems and memory 420 can be distributed.

Processor 430 can be one or more processors. Processor 430 can be a combination of processor types, such as a CPU, a GPU, a single instruction multiple data (SIMD) processor, or other processor types. Processor 430 can be a dedicated processing unit. Processor 430 can be a virtual process supported by a processing unit. Processor 430 can be configured to produce the output, one or more interim outputs, and statuses utilizing the received inputs. Processor 430 can determine the output using parallel processing. Processor 430 can be an integrated circuit. In some aspects, processor 430, communications interface 410, memory 420, or various combinations thereof, can be an integrated circuit. Processor 430 can be configured to direct the operation of AV decision controller 400. Processor 430 includes the logic to communicate with communications interface 410 and memory 420, and can perform the functions described herein. Processor 430 can perform or direct the operations as described by AV decision processor 320 of FIG. 3. In some aspects, AV decision system 300 or AV decision controller 400 can be part of a machine learning system.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
receiving sensor data collected from one or more sensors located with an ego autonomous vehicle (AV), wherein the sensors have known intrinsics;
receiving qualitative decision data involving the ego AV, wherein the qualitative decision data lacks known intrinsics;
determining an AV decision for the ego AV using the sensor data and the qualitative decision data, wherein a set of possible actions towards a high-level goal is evaluated for an original subsequent action of the ego AV, and, for each possible action in the set of possible actions, a weighting of the qualitative decision data relative to the sensor data is adjusted according to an amount of support the qualitative decision data has for the each possible action; and
directing the ego AV to a second subsequent action using the AV decision.

2. The method as recited in claim 1, wherein the qualitative decision data is adjusted to a lower weight when the qualitative decision data provides less support for the each possible action in the set of possible actions.

3. The method as recited in claim 1, wherein the qualitative decision data is adjusted to a higher weight when the qualitative decision data provides more support for the each possible action in the set of possible actions.

4. The method as recited in claim 1, wherein the qualitative decision data is a text description.

5. The method as recited in claim 4, wherein the text description is human annotated.

6. The method as recited in claim 1, wherein the qualitative decision data is received from a database or data storage system.

7. The method as recited in claim 1, wherein the qualitative decision data is processed through a multi-modal large language model (MM-LLM) aligning text and image descriptions of a scene.

8. The method as recited in claim 1, wherein the determining uses a multi-modal encoder.

9. The method as recited in claim 8, wherein the multi-modal encoder encodes the sensor data and the qualitative decision data into a shared latent embedding space by pairing the sensor data or the qualitative decision data with the each possible action.

10. The method as recited in claim 8, wherein the multi-modal encoder is fine-tuned using ego AV action logs.

11. The method as recited in claim 8, wherein the multi-modal encoder is trained using masked inputs.

12. The method as recited in claim 1, wherein the determining uses a latent space sampler.

13. The method as recited in claim 12, wherein the latent space sampler uses learned similarity functions to retrieve semantically k-nearest data points to the qualitative decision data and the set of possible actions.

14. The method as recited in claim 1, wherein the determining uses a decoder and the ego AV is located at a scene.

15. The method as recited in claim 14, wherein the decoder is a diffusion trajectory generation model to predict ego AV behavior, where the ego AV behavior is not biased towards a particular goal.

16. The method as recited in claim 14, wherein the decoder is an LLM decoder that uses the qualitative decision data to infer safety or planning of the ego AV at the scene.

17. The method as recited in claim 14, wherein the decoder produces an output that uses the sensor data and the qualitative decision data relative to the scene, and includes a recommended ego AV plan, a predicted contender AV trajectory, or an evaluation of a candidate plan.

18. A system, comprising:
a data storage system capable of storing qualitative decision data from a scene involving an ego autonomous vehicle (AV);
a sensor system capable of collecting sensor data from one or more sensors; and
an AV decision processor capable of using the sensor data and the qualitative decision data, wherein a set of possible actions is evaluated for an original subsequent action of the ego AV towards a high-level goal, and, for each possible action in the set of possible actions, a weighting of the qualitative decision data relative to the sensor data is adjusted according to an amount of support the qualitative decision data provides for respective of the each possible action, and recommending a second subsequent action to the ego AV.

19. The system as recited in claim 18, wherein the AV decision processor is a central processing unit (CPU), a graphics processing unit (GPU), or a single instruction multiple data (SIMD) processing unit.

20. The system as recited in claim 18, wherein the AV decision processor is located at the ego AV and the second subsequent action is used by the ego AV as the next action of the ego AV.

21. The system as recited in claim 18, wherein the AV decision processor is not located on the ego AV and the second subsequent action is used to train an ego AV decision model.

22. The system as recited in claim 18, wherein the one or more sensors are located at the scene.

23. A non-transitory computer program product having a series of operating instructions stored on a non-transitory computer-readable medium that directs an ego autonomous vehicle (AV) process when executed thereby to perform operations, the operations comprising:
receiving sensor data collected from one or more sensors located with an ego autonomous vehicle (AV), wherein the sensors have known intrinsics;
receiving qualitative decision data involving the ego AV, wherein the qualitative decision data lacks known intrinsics;
determining an AV decision for the ego AV using the sensor data and the qualitative decision data, wherein a set of possible actions towards a high-level goal is evaluated for an original subsequent action of the ego AV, and, for each possible action in the set of possible actions, a weighting of the qualitative decision data relative to the sensor data is adjusted according to an amount of support the qualitative decision data has for each possible action; and
directing the ego AV to a second subsequent action using the AV decision.

24. The non-transitory computer program product as recited in claim 23, wherein the qualitative decision data is adjusted to a lower weight when the qualitative decision data provides less support for the each possible action in the set of possible actions, or the qualitative decision data is adjusted to a higher weight when the qualitative decision data provides more support for the each possible action in the set of possible actions.
